(19) United States
(12) Patent Application Publication
(10) Pub. No.: US 2013/0247191 A1
(43) Pub. Date: Sep. 19, 2013

(54) SYSTEM, METHOD, AND COMPUTER PROGRAM PRODUCT FOR PERFORMING A REMEDIAL ACTION WITH RESPECT TO A FIRST DEVICE UTILIZING A SECOND DEVICE

(71) Applicants: Harish Balasubramanian, Bangalore (IN); Arun Rajaraman, Pune (IN); Ravi Honnavalli Ramachandra Rao, Bangalore (IN)

(72) Inventors: Harish Balasubramanian, Bangalore (IN); Arun Rajaraman, Pune (IN); Ravi Honnavalli Ramachandra Rao, Bangalore (IN)

(21) Appl. No.: 12/437,282

(22) Filed: May 7, 2009

(51) Int. Cl. G06F 21/00; G06F 15/16

(52) U.S. Cl. 726/23; 709/206

(57) ABSTRACT

A system, method, and computer program product are provided for performing a remedial action with respect to a first device utilizing a second device. In use, data is received from a first device at a second device via a network. Additionally, it is determined whether the data is unwanted, utilizing the second device. Furthermore, a remedial action is performed utilizing the second device at least partially blocking the first device from accessing the network, based on the determination.

### FIELD OF THE INVENTION

The present invention relates to detecting unwanted data, and more particularly to performing a remediation with respect to a detection of unwanted data.

### BACKGROUND

Traditionally, security systems have been employed for detecting unwanted data. However, techniques for remediating the existence of unwanted data have generally exhibited various limitations. For example, unwanted data oftentimes infiltrates computing devices via a network connected to such computing devices. Thus, once one of the computing devices is infected with the unwanted data, an outbreak of the unwanted data may occur such that other computing devices may become infected with the unwanted data. To prevent an outbreak, remediation with respect to the infected computing device may be performed.

Unfortunately, such remediation has typically involved manual input, has been delayed as a result of the manual input, and has generally required all computing devices on the network to be disconnected from the network for scanning as a result of the delayed remediation of the first infected computing device. There is thus a need for addressing these and/or other issues associated with the prior art.

### SUMMARY

A system, method, and computer program product are provided for performing a remedial action with respect to a first device utilizing a second device. In use, data is received from a first device at a second device via a network. Additionally, it is determined whether the data is unwanted, utilizing the second device. Furthermore, a remedial action is performed utilizing the second device at least partially blocking the first device from accessing the network, based on the determination.

### BRIEF DESCRIPTION OF THE DRAWINGS

FIG. 1 illustrates a network architecture, in accordance with one embodiment.

FIG. 2 shows a representative hardware environment that may be associated with the servers and/or clients of FIG. 1, in accordance with one embodiment.

FIG. 3A shows a method for performing a remedial action with respect to a first device utilizing a second device, in accordance with one embodiment.

FIG. 3B shows a system for performing a remedial action with respect to a first device utilizing a second device, in accordance with another embodiment.

FIG. 4 shows a method performed by a second device for detecting unwanted data on a first device and remediating the unwanted data detected on the first device, in accordance with yet another embodiment.

FIG. 5 shows a method performed by a second device for detecting unwanted data on a first device and initiating a remediation process, in accordance with still yet another embodiment.

### DETAILED DESCRIPTION

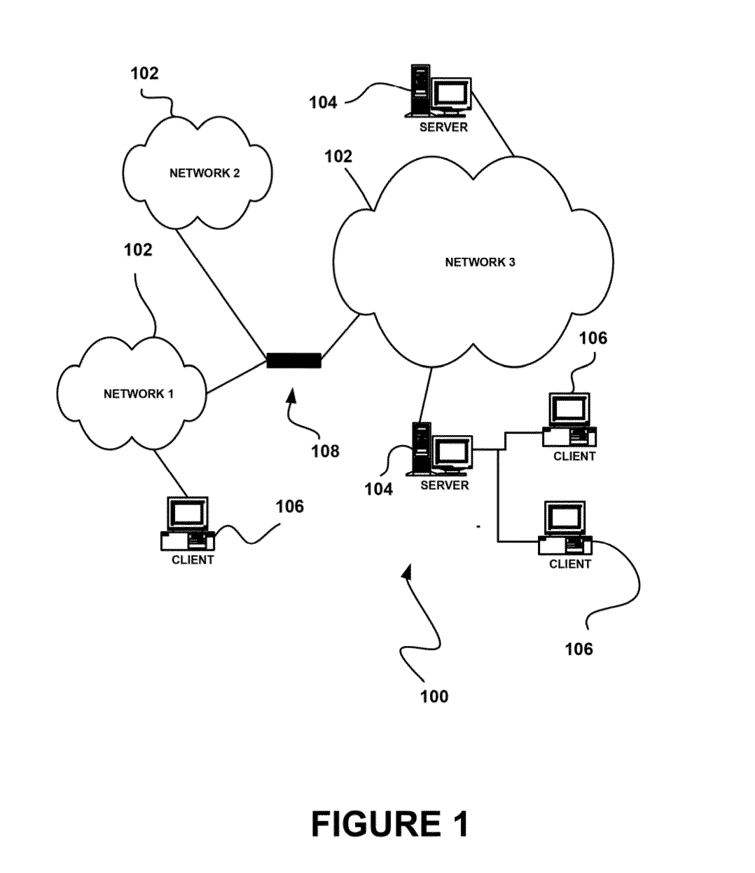

FIG. 1 illustrates a network architecture 100, in accordance with one embodiment. As shown, a plurality of networks 102 is provided. In the context of the present network architecture 100, the networks 102 may each take any form including, but not limited to a local area network (LAN), a wireless network, a wide area network (WAN) such as the Internet, peer-to-peer network, etc.

Coupled to the networks 102 are servers 104 which are capable of communicating over the networks 102. Also coupled to the networks 102 and the servers 104 is a plurality of clients 106. Such servers 104 and/or clients 106 may each include a desktop computer, lap-top computer, hand-held computer, mobile phone, personal digital assistant (PDA), peripheral (e.g. printer, etc.), any component of a computer, and/or any other type of logic. In order to facilitate communication among the networks 102, at least one gateway 108 is optionally coupled therebetween.

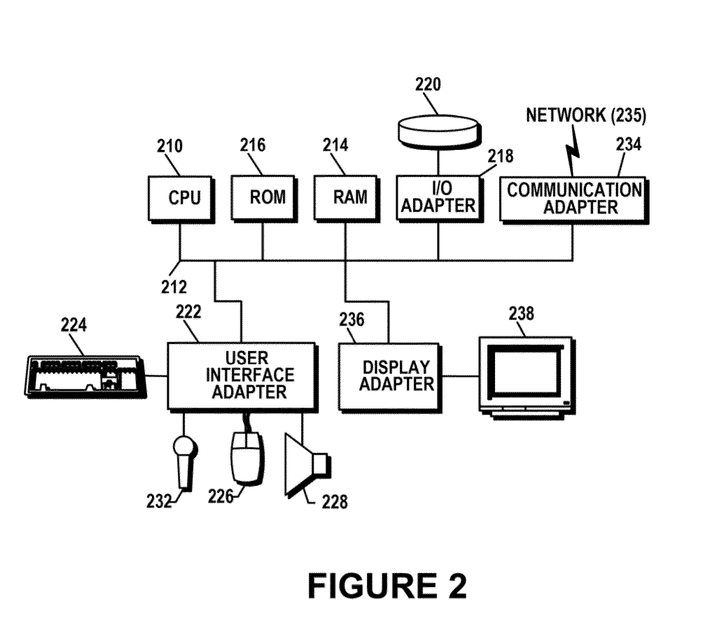

FIG. 2 shows a representative hardware environment that may be associated with the servers 104 and/or clients 106 of FIG. 1, in accordance with one embodiment. Such figure illustrates a typical hardware configuration of a workstation in accordance with one embodiment having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network 235 (e.g., a data processing network) and a display adapter 236 for connecting the bus 212 to a display device 238.

The workstation may have resident thereon any desired operating system. It will be appreciated that an embodiment may also be implemented on platforms and operating systems other than those mentioned One embodiment may be written using JAVA, C, and/or C++ language, or other programming languages, along with an object oriented programming methodology. Object oriented programming (OOP) has become increasingly used to develop complex applications.

Of course, the various embodiments set forth herein may be implemented utilizing hardware, software, or any desired combination thereof. For that matter, any type of logic may be utilized which is capable of implementing the various functionality set forth herein.

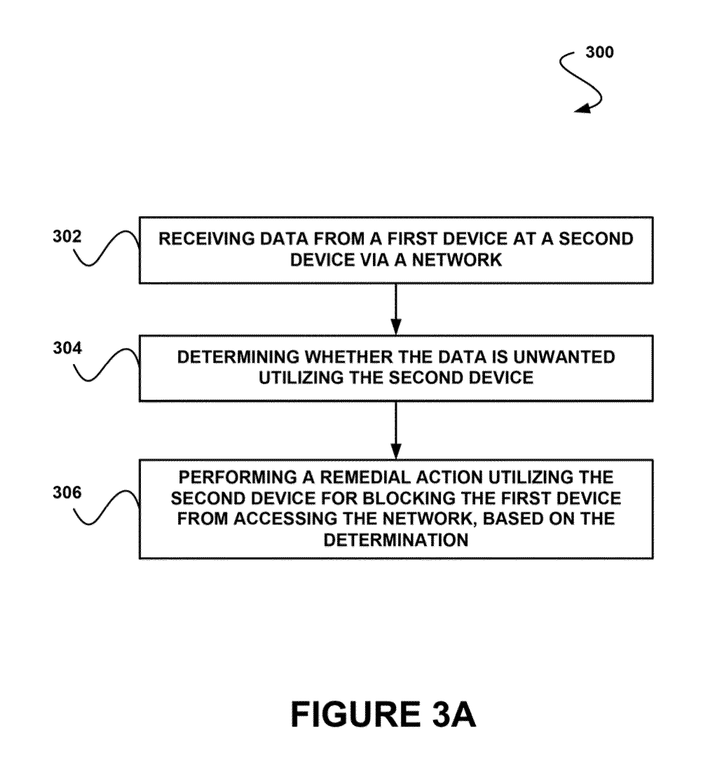

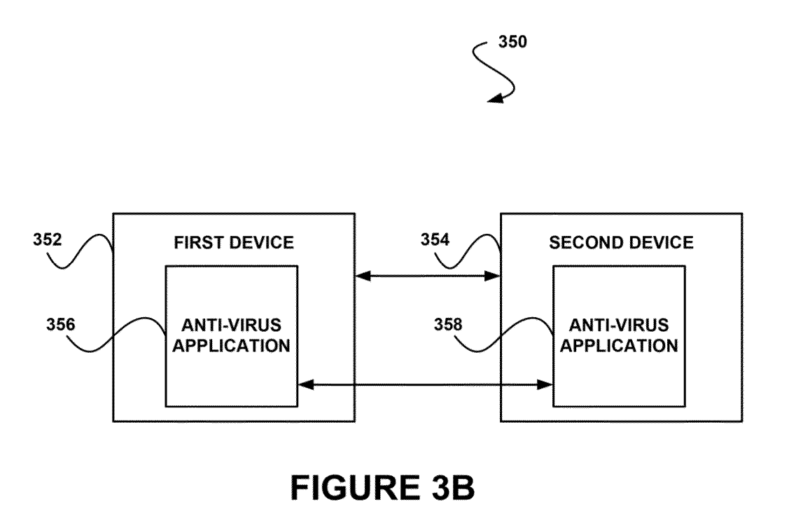

FIG. 3A shows a method 300 for performing a remedial action with respect to a first device utilizing a second device, in accordance with one embodiment. As an option, the method 300 may be carried out in the context of the architecture and environment of FIGS. 1 and/or 2. Of course, however, the method 300 may be carried out in any desired environment.

As shown in operation 302, data is received from a first device at a second device via a network. In the context of the present description, the first device may include any device from which data may be received via the network. For example, the first device may include a client computer, a server computer and/or any of the devices described above with respect to FIGS. 1 and/or 2.

Also in the context of the present description, the second device may include any device capable of receiving the data via the network. Just by way of example, the second device may also include a client computer, a server computer and/or any of the devices described above with respect to FIGS. 1 and/or 2.

In one embodiment, the network via which the data is received by the second device may include the Internet, a LAN, a wired network, a wireless network, and/or any other network over which data may be communicated from the first device to the second device. To this end, the first device and the second device may be coupled to the network for communicating therebetween.

Additionally, the data received from the first device at the second device may include any type of data capable of being communicated over the network. For example, the data may include an instant message (IM), an electronic mail (email) message, downloaded content, a webpage on the first device accessed by the second device via hypertext transfer protocol (HTTP), a file on the first device being downloaded by the second device via file transfer protocol, etc. Of course, however, the data may include any content transferred from the first device to the second device using any desired mechanism. As an option, the data may be received at the second device via an application of the second device, such as an email message application, an instant message application, a content player, etc.

Further, as shown in operation 304, it is determined whether the data is unwanted, utilizing the second device. With respect to the present description, the data may be unwanted if the data is malicious (e.g. includes malware) or is unwanted in any other manner. For example, the data may be unwanted as a result of the data including a virus, a worm, a Trojan, etc.

It should be noted that the data may be determined to be unwanted in any desired manner. In one exemplary embodiment, the second device may determine whether the data is unwanted by scanning the data. For example, the second device may determine whether the data is unwanted by determining whether the data matches known unwanted data (e.g. known malicious data), and identifying the data as unwanted if the data is determined to match the known unwanted data.

Such known unwanted data may optionally include a plurality of signatures of known unwanted data. As another option, the known unwanted data may be stored in a database. In addition, the database may be stored on the second device. For example, the database may be stored in association with a security system of the second device. In this way, the security system may utilize the database to determine whether the data is unwanted.

Moreover, a remedial action is performed utilizing the second device for at least partially blocking the first device from accessing the network, based on the determination. Note operation 306. To this end, if it is determined that the data is not necessarily unwanted, the remedial action may not be performed. However, the remedial action may optionally only be performed in response to a determination that the data is unwanted. In this way, the remedial action may be utilized for remediating the first device with respect to the unwanted data, as an option.

In one embodiment, the remedial action may include communicating with the first device via an intra-networking capability of the first device and the second device. The intra-networking capability may include communicating between the security system (e.g. antivirus scanner) of the first device and the security system (e.g. antivirus scanner) of the second device. In various exemplary embodiments, the intra-networking capability may utilize a secure channel for allowing communications thereover, such as via a predetermined port, a handshake (e.g. to ensure it is the first device security system and the second device security system communicating, etc.), a digital signature, etc.

Thus, as an option, the remedial action may include the second device communicating with the first device via the intra-networking capability for at least partially blocking the first device from accessing the network. It should be noted that any of the further exemplary remedial actions described below may optionally be performed utilizing the intra-networking capability.

In another embodiment, the remedial action may include blocking ports (e.g. inbound ports and/or outbound ports) of the first device for at least partially blocking the first device from accessing the network. By blocking such ports, the first device may be incapable of communicating via the network. In this way, the first device may be incapable of sending the unwanted data to another device on the network and thus an outbreak of the unwanted data may be prevented.

As an option, the ports may include all ports of the first device. As another option, the ports may be blocked for all processes, with an exception for processes predetermined to be for use in remediating the first device (e.g. security system processes). Accordingly, communications to the first device over the network may only be allowed if such communications are for remediation purposes and/or are from/to the security system of the first device (e.g. for updating signatures of the security system of the first device, etc.).

In yet another embodiment, the remedial action may include determining whether a port manager of the first device is enabled (e.g. by requesting a status of the port manager from the first device), and enabling the port manager if it is determined that the port manager is disabled. For example, the second device may instruct the first device to enable the port manager. The port manager may include any application capable of managing communication over the ports of the first device, such as by configuring the ports to block or allow communications thereover as desired.

In still yet another embodiment, the remedial action may include determining (e.g. by querying the first device) whether the port manager includes a rule for blocking communication over all ports of the first device for all processes except processes required for remediation purposes (e.g. security system processes of the first device such as anti-virus system processes, signature updater processes, etc.). The rule may be created via the remedial action if it is determined that the rule is nonexistent on the first device. The port blocking rule may then be enabled.

In this way, the remedial action may include instructing the first device to block communication over all ports of the first device for all processes except processes utilized for remediation of the first device. By allowing the expert processes of the first device, communications between the first device and the second device (or optionally between the first device and any other device on the network with such intra-networking capabilities) which are for use in remediating the first device may be allowed (e.g. not necessarily blocked). Of course, while various examples of at least partially blocking access to the network by the first device have been described above, it should be noted that such access may be blocked in any desired manner.

In another embodiment, the remedial action may include initiating an update to the first device (e.g. to the security system of the first device). For example, the update may include an update to signatures of the security system of the first device. Such signatures may optionally be utilized by the security system of the first device for detecting unwanted data. Furthermore, the remedial action may include unblocking any blocked access of the first device to the network, in response to the performance of the update to the first device. For example, the update may indicate that the first device is protected from known unwanted data.

Thus, once the first device is updated, access to the network by the first device may be unblocked (e.g. by unblocking the blocked ports of the first device, etc.) since it may be ensured that the first device is protected from known unwanted data. By updating the first device in response to the detection by the second device of the unwanted data on the first device (e.g. by virtue of the receipt of the unwanted data from the first device at the second device), the first device may be updated on-demand without necessarily waiting for a periodically scheduled update to occur.

In yet another embodiment, the remedial action may include removing the data determined to be unwanted. The data may be removed in any desired manner for cleaning the first device of the unwanted data. For example, if the data includes a file, the file may be deleted from the first device. The remedial action may also optionally include quarantining the first device, in another embodiment.

Still yet, the remedial action may include identifying a process and/or a thread of the first device via which the data was received from the first device by the second device. For example, the process and/or thread may be responsible for sending the unwanted data from the first device to the second device. As an option, the process and/or thread may be identified based on logging performed by the first device and/or the second device. The logging may indicate the transmission of the data from the first device to the second device, a port utilized for the transmission, an application from which the data was transmitted, and/or any other information associated with the unwanted data that may be utilized for identifying the process and/or thread via which the data was received from the first device by the second device.

Moreover, the remedial action may optionally include terminating the identified process and/or thread. In one embodiment, the process and/or thread may be terminated based oil a determination of whether the process and/or thread is predetermined to be good. The predetermined good process and/or thread may include a process and/or thread otherwise utilized for non-malicious purposes (e.g. a non-malicious process and/or thread which was utilized for sending the unwanted data), such as a known operating system process and/or thread).

In response to a determination that the process and/or thread is not a predetermined good process and/or thread (e.g. does not match a predetermined good process and/or thread and thus is malicious), the process and/or thread may be terminated by killing the same. Further, the remedial action may include cleaning up registry entries, start-up configurations, etc. associated with the killed process and/or thread. As another option, in response to a determination that the process and/or thread is a predetermined good process and/or thread (e.g. matches a predetermined good process and/or thread and thus is generally non-malicious), the process and/or thread may be terminated by gracefully shutting down the same.

As yet another option, the identified process and/or thread may be correlated with the unwanted data and mapped to a file (e.g. a file including the data, if it exists). As noted above, the process can be shutdown [or the thread in the process associated with the unwanted data if the process itself is known to be good, such as a structured query language (SQL) process]. If the process is not known to be good, then the process may be killed, as also noted above, and the corresponding data (e.g. file) remediated, removing any standard registry hooks or other startup methods. Additionally, the data (e.g. file) itself and/or a fingerprint thereof may be reported to a central server and auto-populated as a security system signature update across any desired devices in communication with the central server.

In addition, the remedial action may include restarting the terminated process and/or thread in response to the update of the first device described above. For example, the process and/or thread may only be restarted if the same is determined to be a predetermined good process and/or thread.

In yet another embodiment, the remedial action may include notifying another device (e.g. a central server) of the unwanted data, where such notification is optionally provided over a network. The notification may initiate performance of a further remedial action by such other device for at least partially blocking the first device from accessing the network. It should be noted that the further remedial action may include any of the aforementioned remedial actions.

By the second device determining data received from the first device to be unwanted by the second device, and further performing the remedial action for at least partially blocking the first device from accessing the network, the unwanted data at the first device may be automatically remediated, thus preventing a requirement of manual intervention. The automatic remediation may allow the remediation to be performed without delay (as opposed to delay caused by a requirement of manual intervention). Additionally, such automatic remediation may prevent the unwanted data from being communicated to other devices on the network, thus preventing the other devices from otherwise being required to be disconnected from the network.

More illustrative information will now be set forth regarding various optional architectures and features with which the foregoing technique may or may not be implemented, per the desires of the user. It should be strongly noted that the following information is set forth for illustrative purposes and should not be construed as limiting in any manner. Any of the following features may be optionally incorporated with or without the exclusion of other features described.

FIG. 3B shows a system 350 for performing a remedial action with respect to a first device utilizing a second device, in accordance with another embodiment. As an option, the system 350 may be implemented in the context of the architecture and environment of FIGS. 1-3A. For example, the second device 354 of the system 350 may perform the method 300 of FIG. 3A. Of course, however, the system 350 may be implemented in any desired environment. It should also be noted that the aforementioned definitions may apply during the present description.

As shown, a first device 352 is in communication with a second device 354. While note shown, it should be noted that in the context of the present embodiment, the first device 352 and the second device 354 are in communication via a network. The first device 352 and the second device 354 may be in communication by way of the network in any desired manner, such as via email, instant messaging, etc.

To this end, the first device 352 may send data to the second device 354 via the network. In response to receipt of the data by the second device 354, the second device 354 may determine whether the data is unwanted. For example, the anti-virus application 358 of the second device 354 may scan the data for determining whether the data is unwanted.

In one embodiment, the second device 354 may determine that the data is unwanted. For example, the second device 354 may include a security system (e.g. the anti-virus application 358 of the second device 354) with at least one signature (e.g. for use in detecting unwanted data) that is absent from a security system (e.g. the anti-virus application 356) of the first device 352. As another example, the first device 352 may include a security system with outdated signatures, whereas the second device 354 may include a security system with up-to-date signatures (e.g. with more up-to-date signatures for use in detecting unwanted data than a security system of the first device). Thus, the first device 352 may be incapable of detecting the unwanted data since the signatures for doing so may be nonexistent on the first device 352, whereas the second device 354 may have the signatures for detecting the unwanted data and therefore may be capable of detecting the unwanted data.

Furthermore, based on the determination of whether the data is unwanted, the second device 354 performs a remedial action for at least partially blocking the first device 352 from accessing the network. For example, if the second device 354 determines that the data received by the first device 352 is unwanted, the second device 354 may perform the remedial action. The remedial action may include the second device 354 at least partially blocking the first device 352 from accessing the network (e.g. by blocking ports and/or processes of the first device 352). As another option, the remedial action may include notifying another device (e.g. a central server) of the unwanted data, such that the other device may at least partially block the first device 352 from accessing the network.

In one embodiment, the first device 352 and the second device 354 (and optionally the other device) each include an intra-networking capability. The intra-networking capability may allow communication between security components of the first device 352 and the second device 354 via the network. For example, the intra-networking capability may enable communication between a first anti-virus application 356 of the first device 352 and a second anti-virus application 358 of the second device 354. In this way, the intra-networking capability may be utilized for at least partially blocking the first device 352 from accessing the network.

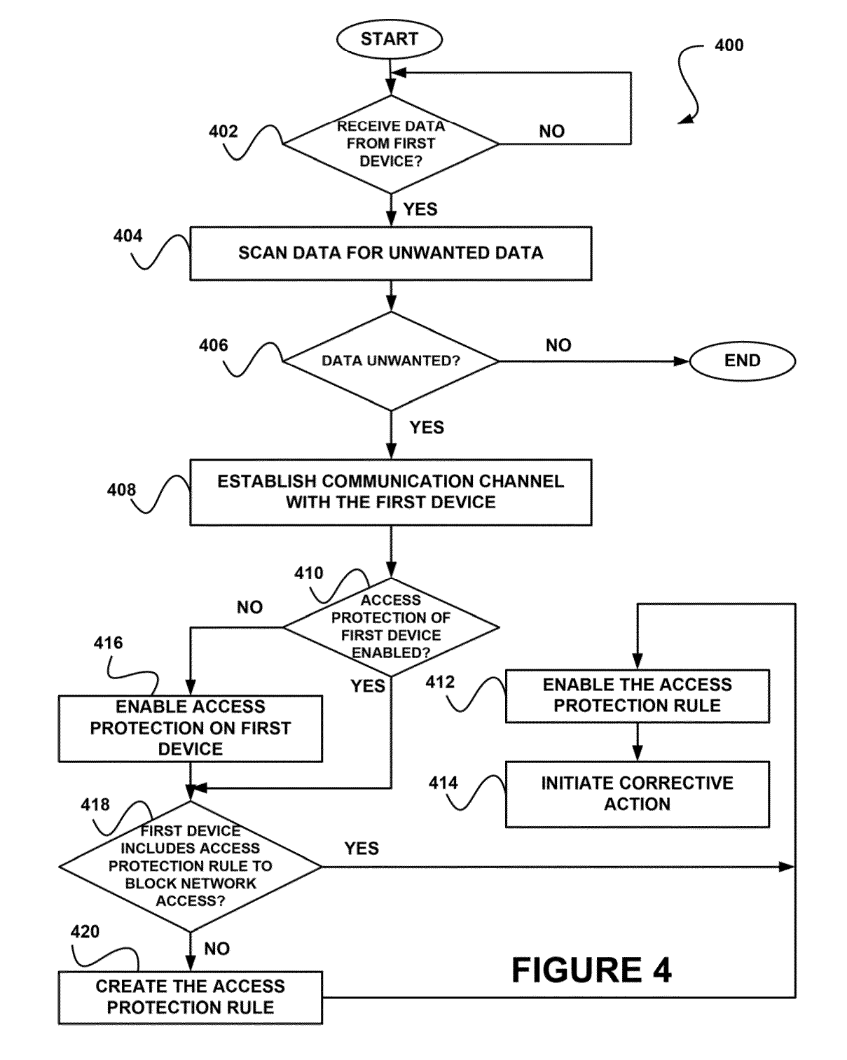

FIG. 4 shows a method 400 performed by a second device for detecting unwanted data on a first device and remediating the unwanted data detected on the first device, in accordance with yet another embodiment. As an option, the method 400 may be carried out in the context of the architecture and environment of FIGS. 1-3 B. For example, the method 400 may be carried out by the second device 354 of the system 350 of FIG. 3A. Of course, however, the method 400 may be carried out in any desired environment. It should also be noted that the aforementioned definitions may apply during the present description.

As shown in decision 402, it is determined whether data is received from a first device. With respect to the present embodiment, the received data includes data received over a network. For example, the data may be received via email, an IM, a download, etc.

If it is determined that data is not received from the first device, the method 400 continues to wait for data to be received from the first device. However, in response to a determination that data is received from the first device, the data is scanned for unwanted data. Note operation 404. The data may be scanned by comparing the data to signatures of known unwanted data, just by way of example.

It is further determined whether the data is unwanted, as shown in decision 406. The determination may be made based on the scanning of the data. For example, if the scanning results indicate that the data matches a signature of known unwanted data, the data may be determined to be unwanted. If the scanning results indicate that the data does not match any signature of known unwanted data, the data may not necessarily be determined to be unwanted.

If it is determined that the data is not unwanted (e.g. that the data does not match any signature of known unwanted data), the method 400 terminates. If, however, it is determined that the data is unwanted, a communication channel with the first device is established. Note operation 408. In one embodiment, the communication channel may include an intra-networking communication channel provided by way of intra-networking capabilities of the first device and the device at which the data was received. In another embodiment, the communication channel may include a secure communication channel (e.g. over a predetermined port). To this end, a remedial action may be performed (e.g. via the communication channel) for at least partially blocking the first device from accessing the network.

Further, as shown in decision 410, it is determined whether access protection of the first device is enabled. With respect to the present embodiment, the access protection includes a port manager of the first device (e.g. include any application capable of managing communication over the ports of the first device, such as by configuring the ports to block or allow communications thereover as desired). The determination of whether the access protection is enabled may optionally be made by requesting a status of the access protection from the first device.

If it is determined that the access protection is not enabled on the first device, the access protection is enabled. Note operation 416. The access protection may be enabled by changing a status of the access protection from disabled to enabled, in one embodiment.

Once the access protection is enabled (e.g. via the determination that the access protection rule is already enabled in decision 410 or upon enabling the access protection rule in operation 416), it is determined whether the first device includes an access protection rule to block network access by the first device with an exception for processes and/or threads required for the remediation of the first device (e.g. security system processes and/or threads). Note decision 418. Such determination may optionally be made by searching a database of access protection rules for a predetermined access protection rule that may be utilized to perform the aforementioned function.

If it is determined that an access protection rule does not exist on the first device for blocking network access by the first device with an exception for processes and/or threads required for the remediation of the first device, such an access protection rule is created, as shown in operation 420. The access protection rule may be created from a template, by copying an existing access protection rule (e.g. on the device which received the unwanted data), etc.

If it is determined in decision 418 that the first device includes the particular access protection rule noted above, or in response to the creation of the access protection rule in operation 420, the access protection rule is enabled. Note operation 412. Enabling the access protection rule may result in network access by the first device being blocked with an exception for processes and/or threads required for the remediation of the first device, such that the unwanted data may be prevented from being spread to other devices on the network.

Moreover, corrective action is initiated, as shown in operation 414. In one embodiment, the corrective action may include removing the unwanted data from the first device. In another embodiment, the corrective action may include terminating a process and/or thread from which the unwanted data was received. In yet another embodiment, the corrective action may include updating the first device to prevent the first device from being re-infected with the unwanted data after the removal thereof and from being infected with any other known unwanted data.

In one exemplary embodiment, a first device (M1) and a second device (M2) are present in a network where M1 is a compromised device due to anti-virus signatures being out-of-date, and is thus infected with a virus. M2, however, is a device with up-to-date anti-virus signatures.

The virus on M1 attempts to spread to M2, for example, over email, instant messaging, etc. M2, having up-to-date anti-virus signatures, detects the incoming sample as a virus via the up-to-date anti-virus signatures.

Anti-virus software on M2 communicates over the network using its already existing intra-networking capability with the anti-virus software on M1 to perform a remedial action for at least partially blocking M1 from accessing the network. M2 may block all network ports on M1 such that it is unable to spread the virus to other devices in the network. M2 further exempts (if blocked) only the required software (e.g. processes, threads, etc. of applications) for remediation of the first device. Such blocking may thus be used to at least partially block M1 from accessing the network, thus preventing an outbreak of the virus.

The blocking with exemptions may be achieved by enabling access protection if disabled and creating (or enabling, if already defined) an access protection rule to block communication over all inbound/outbound ports for all processes exempting only the required ones for remediation of the first device (e.g., anti-virus software, anti-virus signature updater, etc.). In addition, the blocking with exemptions may be achieved by M2 identifying the process and/or thread responsible for sending the data with the virus, where the process and/or thread is shut down gracefully if the same is known to be good, or may otherwise be killed and the corresponding registry entries and startup configurations cleaned up.

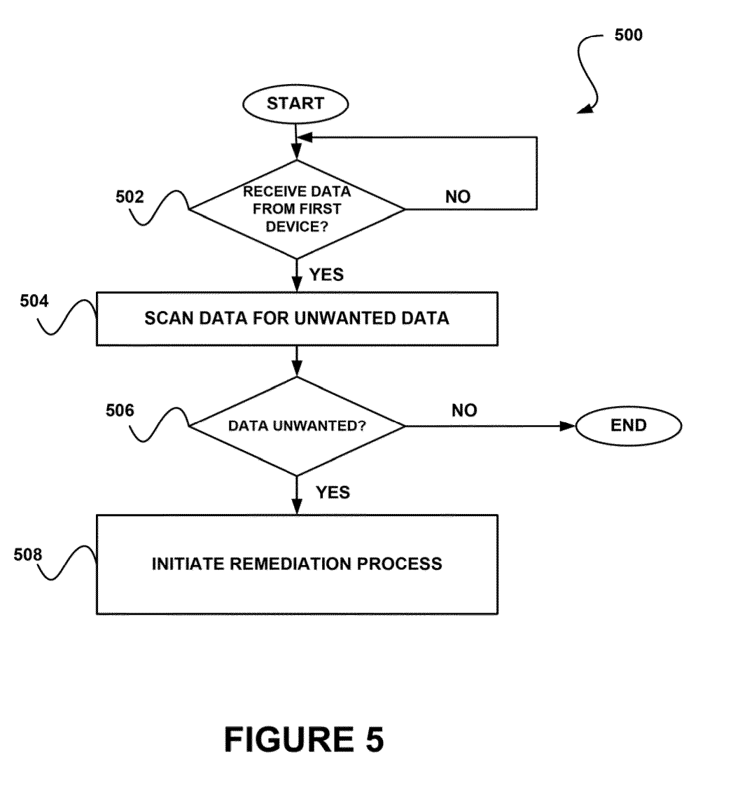

If the data with the virus is a file in a secondary storage of M1, M2 may clean the same and take necessary actions (e.g. quarantining the infected file on M1, etc.). M2 may further initiate an immediate update of M1, such as anti-virus signatures of M1. Once the update is successfully complete, the blocked network ports may be unblocked. In this way, M1 may effectively be back on the network. M2 may restart the process and/or thread that was terminated, as described above, such that M1 may be running in a clean state. It should be noted that as described below with respect to FIG. 5, the blocking with exemptions may be performed by a central server in response to notification of the virus and/or an instruction to do so from M2.

FIG. 5 shows a method 500 performed by a second device for detecting unwanted data on a first device and initiating a remediation process, in accordance with still yet another embodiment. As an option, the method 500 may be carried out in the context of the architecture and environment of FIGS. 14. For example, the method 500 may be carried out by the second device 354 of the system 350 of FIG. 3A. Of course, however, the method 500 may be carried out in any desired environment. It should also be noted that the aforementioned definitions may apply during the present description.

As shown in decision 502, it is determined whether data is received from a first device. With respect to the present embodiment, the received data includes data received over a network. For example, the data may be received via email, an IM, a download, etc.

If it is determined that data is not received from the first device, the method 400 continues to wait for data to be received from the first device. However, in response to a determination that data is received from the first device, the data is scanned for unwanted data. Note operation 504. The data may be scanned by comparing the data to signatures of known unwanted data, just by way of example.

It is further determined whether the data is unwanted, as shown in decision 506. The determination may be made based on the scanning of the data. For example, if the scanning results indicate that the data matches a signature of known unwanted data, the data may be determined to be unwanted. If the scanning results indicate that the data does not match any signature of known unwanted data, the data may not necessarily be determined to be unwanted.

If it is determined that the data is not unwanted (e.g. that the data does not match any signature of known unwanted data), the method 500 terminates. If, however, it is determined that the data is unwanted, a remediation process is initiated for at least partially blocking the first device from accessing the network. Note operation 508.

With respect to the present embodiment, the remediation process may include notifying a remote server of the unwanted data, such that the remote server may take any desired remedial actions to at least partially block the first device from accessing the network. For example, the remote server may block ports of the first device for all processes and/or threads with an exception for processes and/or threads predetermined to be for use in remediating the first device (e.g. security system processes and/or threads), may initiate an update of the first device, may remove the unwanted data from the first device, etc.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A computer program product embodied on a non-transitory computer readable medium for performing operations, comprising:
receiving data from a first device at a second device via a network;
determining whether the data is unwanted;
performing a remedial action utilizing the second device, wherein the remedial action is performed-over a secure channel of a predetermined port through an intra-networking capability between a first anti-virus application of the first device and a second anti-virus application of the second device;
wherein performing the remedial action through the intra-networking capability comprises:
determining whether a port manager of the first device is enabled;
enabling the port manager if it is determined that the port manager is disabled;
determining whether the port manager includes an access protection rule for blocking communication over all ports of the first device for processes except security system processes of the first device by searching a database of rules for the access protection rule;
creating the rule if it is determined that the rule is nonexistent in the database; and
enabling the rule if it is determined that the rule is existent on the database.

2. The computer program product of claim 1, wherein the data includes at least one of an instant message, an electronic mail message, a webpage on the first device accessed by the second device via hypertext transfer protocol, and a file on the first device being downloaded by the second device via file transfer protocol.

3. The computer program product of claim 1, wherein the first device includes a security system with outdated signatures for use in detecting unwanted data.

4. The computer program product of claim 1, wherein the second device includes a security system with more up-to-date signatures for use in detecting unwanted data than a security system of the first device.

5. The computer program product of claim 1, wherein the determining whether the data is unwanted comprises:
determining whether the data matches known unwanted data; and
identifying the data as unwanted if the data matches the known unwanted data.

6. The computer program product of claim 1, wherein the computer code is operable such that the remedial action is only performed in response to a determination that the data is unwanted.

7. (canceled)

8. (canceled)

9. The computer program product of claim 1, wherein the remedial action includes blocking ports of the first device for at least partially blocking the first device from accessing the network.

10. (canceled)

11. (canceled)

12. The computer program product of claim 1, wherein the remedial action includes removing the data determined to be unwanted.

13. The computer program product of claim 1, wherein the remedial action includes terminating a process or a thread of the first device via which the data was received from the first device at the second device.

14. The computer program product of claim 13, wherein terminating the process or the thread includes killing the process or the thread in response to a determination that the process or the thread is malicious or gracefully shutting down the process or the thread in response to a determination that the process or thread is a predetermined good process or thread.

15. The computer program product of claim 1, wherein the remedial action includes initiating an update to signatures of a security system located on the first device.

16. The computer program product of claim 15, wherein the remedial action further includes unblocking the blocked ports of the first device, in response to performance of the update to the signatures.

17. The computer program product of claim 1, wherein the remedial action includes notifying a central server of the data determined to be unwanted for initiating the central server to at least partially block the first device from accessing the network.

18. A method, comprising:
receiving data from a first device at a second device via a network;
determining whether the data is unwanted;
performing a remedial action utilizing the second device, wherein the remedial action is performed-over a secure channel of a predetermined port through an intra-networking capability between a first anti-virus application of the first device and a second anti-virus application of the second device;
wherein performing the remedial action through the intra-networking capability comprises:
determining whether a port manager of the first device is enabled;
enabling the port manager if it is determined that the port manager is disabled;
determining whether the port manager includes an access protection rule for blocking communication over all ports of the first device for processes except security system processes of the first device by searching a database of rules for the access protection rule;
creating the rule if it is determined that the rule is nonexistent in the database; and
enabling the rule if it is determined that the rule is existent on the database.

19. A system, comprising:
a processor, wherein the system is configured for:
receiving data from a first device via a network,
determining whether the data is unwanted,
performing a remedial action, wherein the remedial action is performed over a secure channel of a predetermined port through an intra-networking capability between a first anti-virus application of the first device and a second anti-virus application of the system,
wherein performing the remedial action through the intra-networking capability comprises:
determining whether a port manager of the first device is enabled,
enabling the port manager if it is determined that the port manager is disabled;
determining whether the port manager includes an access protection rule for blocking communication over all ports of the first device for processes except security system processes of the first device by searching a database of rules for the access protection rule;
creating the rule if it is determined that the rule is nonexistent in the database; and
enabling the rule if it is determined that the rule is existent on the database.

20. The system of claim 19, wherein the processor is coupled to memory via a bus.
